(19) United States
(12) Patent Application Publication
(10) Pub. No.: US 2016/0303916 A1
(43) Pub. Date: Oct. 20, 2016

(54) Tire Having a Particular Graphic Element

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Eric Berger, Clermont-Ferrand (FR); Benoit GARDARIN, Clermont-Ferrand (FR); Bruno GUIMARD, Clermont-Ferrand (FR); Olivier MUHLHOFF, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/103,657

(22) PCT Filed: Dec. 5, 2014
(86) PCT No.: PCT/EP2014/076685

§ 371 Date: Jun. 10, 2016

(30) Foreign Application Priority Data
Dec. 11, 2013 (FR) 1362401

(51) Int. Cl. B60C 11/01; B60C 11/03

(52) U.S. Cl. CPC B60C 11/01; B60C 11/03; B60C 2011/013

(57) ABSTRACT

The disclosure relates to a tire made of rubbery material comprising a tread comprising a shoulder region, and a graphic element. The graphic element is recessed into the shoulder region, and comprises a texture that contrasts with this shoulder region . The graphic element may be selected from a group of graphic elements comprising at least letters, numbers and symbols.

### CROSS-REFERENCE TO RELATED APPLICATIONS

This application is a 371 national phase entry of PCT/EP2014/076685, filed 5 Dec. 2014, which claims the benefit of French Patent Application No. 1362401, filed 11 Dec. 2013, the contents of which are incorporated herein by reference for all purposes.

### BACKGROUND

The present disclosure relates to a tire for a motor vehicle comprising a particular graphic element.

Tire sidewalls have a great many markings intended to provide technical and legal information or to allow consumers to discern the origin of the product.

Attempts are constantly being made at improving the visibility and legibility of these markings on tire sidewalls.

Document US 2008/0283169 describes a tire made of rubbery material comprising a sidewall and a marking formed on this sidewall. The marking is positioned in a housing recessed into the sidewall. This marking protrudes from the bottom of the housing so that it enjoys good visibility on the tire sidewall.

However, during running, large amounts of mud or dust may become lodged in the housing, thereby reducing the contrast between the marking and the bottom of the housing.

There is therefore a need to propose a solution that allows high-contrast marking to be preserved on the sidewall of a tire as this tire runs.

A “tire” means any type of resilient tire whether or not subjected to an internal pressure.

The “tread” of a tire means a quantity of rubbery material delimited by lateral surfaces and by two main surfaces, one of which is intended to come into contact with a roadway when the tire is being driven on.

The “sidewall” of a tire means a lateral surface of the tire positioned between the tread of the tire and the bead of this tire.

A “graphic element” on a sidewall means all or part of a marking present on this sidewall.

A “strand” means a filiform element of which the height is at least equal to twice the diameter of a disc having the same surface area as a mean cross section of this strand.

The “mean cross section” of a strand means the mean of the cross sections measured at regular intervals from the base of the strand to the tip of this strand.

A “lamella” means elongate strands that have a length at least equal to twice their height.

The “mean width” of a lamella means the mean of the widths measured at regular intervals from the base of the lamella to the top of this lamella.

A “texture that contrasts with the shoulder region” means that the difference in luminance between this (lighter) shoulder region and this (darker) texture is at least 5 points. The luminances of the texture and of the shoulder region can be determined using a spectrocolorimeter such as the KONICA-MINOLTA CM 700D (registered trade name). This device is suited to measuring:

the luminosity L*1, L*2 of the shoulder region and of the background of the graphic element covered by the texture;

a component a* which defines a first shade of colour between red and green;

a component b* which defines a second shade of colour between yellow and blue. This device is positioned on the part of the tire that is to be measured and the said device gives the values of the three parameters L*, a*, b* relating to the measured region. These measurements are taken using the “SCI” (specular component included) mode, set at an angle of 10° and with a D65 type light setting (setting as defined by the International Commission on Illumination (CIE)). Using this device, the luminosity of the texture is quantified and can then be compared against the luminosity of the shoulder region.

### SUMMARY

The disclosure relates to a tire made of rubbery material comprising a tread comprising a shoulder region and a graphic element. The graphic element is recessed into the said shoulder region and comprises a texture that contrasts with this shoulder region.

The disclosure thus proposes to provide a graphic element that is recessed into a shoulder region of the tire. Because this shoulder region is subjected to numerous passages of air as the tire runs, the fact that the graphic element is recessed into rather than protruding from this shoulder region limits the resistance to the flow of the air and accordingly improves the energy performance of the vehicle fitted with such tires. This shoulder region is a region which offers good visibility for communicating information to a user looking at the tire once the tire has been fitted to the vehicle. The graphic element, because it is recessed, is less visible in this shoulder region. The texture that forms the subject matter of the disclosure makes it possible to compensate for this lack of visibility. More specifically, this texture traps all or some of the incident rays of light that encounter the graphic element. This makes it possible to give this graphic element a darker appearance thereby improving its contrast and therefore its visibility against the rest of the sidewall. On the other hand, this particular texture makes it possible to obtain a pleasant “velour-like” feel in the region of the graphic element. Finally, the texture used has hydrophobic properties which means that it is easier for water, dust or mud to drain from the graphic element, which is recessed into the shoulder region.

In one alternative form of embodiment, the texture comprises a plurality of strands distributed in this graphic element at a density at least equal to five strands per square millimetre (mm²), each strand having a mean cross section of between 0.0007 mm² and 0.06 mm².

In another alternative form of embodiment, the texture comprises a plurality of substantially mutually parallel lamellae, the spacing of the lamellae being at most equal to 0.5 mm, all or some of the lamellae having a mean width of between 0.03 mm and 0.3 mm.

In one alternative form of embodiment, the graphic element is selected from a group of graphic elements comprising at least: letters, numbers, symbols.

In another alternative form of embodiment, the strands of the graphic element or, respectively, the lamellae of the graphic element, end flush with the shoulder region of the tread of the tire.

In this way, these strands or respectively, these lamellae are in the continuation of the external surface of the shoulder region of the tire. The visual impression of the shoulder region as a whole is thus improved.

In another alternative form of embodiment, the strands of the graphic element or, respectively, the lamellae of the graphic element are set back in relation to the shoulder region of the tread of the tire.

The shoulder region of the tire thus protects the texture of strands and/or lamellae against mechanical attack that this shoulder region may suffer. This then improves the durability of the texture.

In another alternative form of embodiment, the strands of the graphic element or, respectively, the lamellae of the graphic element protrude beyond the shoulder region of the tread of the tire.

The emerging parts of the strands or, respectively, of the lamellae, have a certain flexibility because of their slenderness. When the texture experiences rubbing, these strands or, respectively, these lamellae, deform, thereby absorbing some of the force of this rubbing. In this way, the graphic element is protected against wear and becomes more durable. Furthermore, the fact that the strands or, respectively, the lamellae, of the texture protrude beyond the shoulder region of the tread of the tire affords an overall improvement to the tactile effect of the texture.

In one preferred embodiment, part of the strands of the graphic element or, respectively, part of the lamellae of the graphic element protrude beyond the shoulder region of the tread of the tire and another part of these strands or, respectively, of these lamellae are set back in relation to this shoulder region.

This makes it possible to strike a good balance between protecting the texture on the one hand and protecting the graphic element on the other.

In one alternative form of embodiment, with the tread comprising at least two adjacent grooves opening into the shoulder region, the graphic element is situated between these two adjacent grooves.

This then improves the visibility of the graphic element in the shoulder region still further.

### BRIEF DESCRIPTION OF THE DRAWINGS

Further features and advantages of the disclosure will become apparent from the following description, given by way of nonlimiting example, with reference to the attached drawings in which:

FIG. 1 is a schematic perspective view of a tread comprising a shoulder region and sidewall of a tire and a graphic element present in this shoulder region;

FIG. 2 illustrates how the axial edge of a tread is determined according to a first method for determining it;

FIG. 3 illustrates how the axial edge of a tread is determined according to a second method of determining it;

FIG. 4 is a section on X-X′ of FIG. 1, of a graphic element according to a first embodiment of the disclosure;

FIG. 5 is a section on X-X′ of FIG. 1, of a graphic element according to a second embodiment of the disclosure;

FIG. 6 is a section on X-X′ of FIG. 1, of a graphic element according to a third embodiment of the disclosure;

FIG. 7 depicts the condition of the texture present in the graphic element of FIG. 6 when the shoulder region experiences mechanical forces;

FIG. 8 is a section on X-X′ of FIG. 1, of a graphic element according to a fourth embodiment of the disclosure;

FIG. 9 is a schematic view of a texture present in the graphic element of FIG. 1 and comprising strands;

FIG. 10 is a schematic view of a texture present in the graphic element of FIG. 1 and comprising lamellae.

In the description which will follow, elements that are substantially identical or similar will be denoted by identical references.

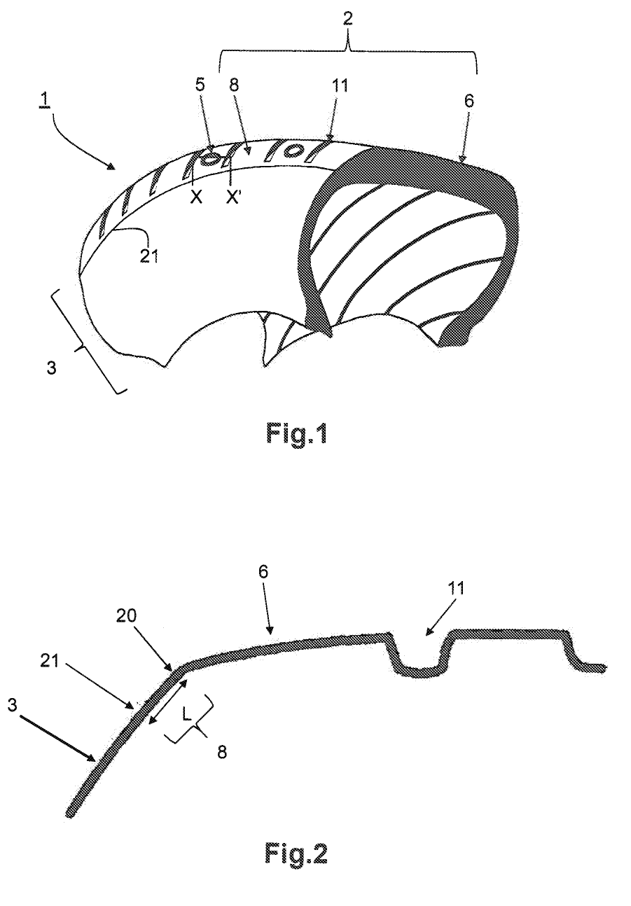

FIG. 1 depicts a sidewall 3 and a tread 2 of a tire 1. This tread 2 of a tire 1 comprises a region referred to as the working region 6 which is intended to come into contact with the ground, and a shoulder region 8 which is not intended to come into contact with the ground when running in a straight line and at the rated loads and pressures. It will be noted that the tread 2 is made up of grooves 11 (also referred to as tread patterns). Hence, the shoulder region 8 also comprises grooves 11 as illustrated in FIG. 1. The shoulder region 8 is a region of transition between the sidewall 3 and the working region 6.
As illustrated in FIG. 1, the shoulder region 8 comprises a graphic element 5. That allows somebody looking at the tire to see the graphic element 5 better. The graphic element 5 is recessed into the said shoulder region 8. As the shoulder region 8 is subjected to numerous passages of air, the fact that the graphic element 5 is recessed means that the flow of air over said shoulder region 8 is not disturbed. The graphic element 5 is situated on the outboard side of the vehicle, so as to be visible.
In one nonlimiting embodiment, the graphic element 5 is situated a distance of 30 mm or less away from the transverse grooves 11 of the tread 2.
In addition, in one nonlimiting embodiment, the graphic element 5 is situated a distance of 30 mm or less away from a wearing region of the tread 2, and on the outside thereof when the tread wear reaches the tread wear limit indicators.

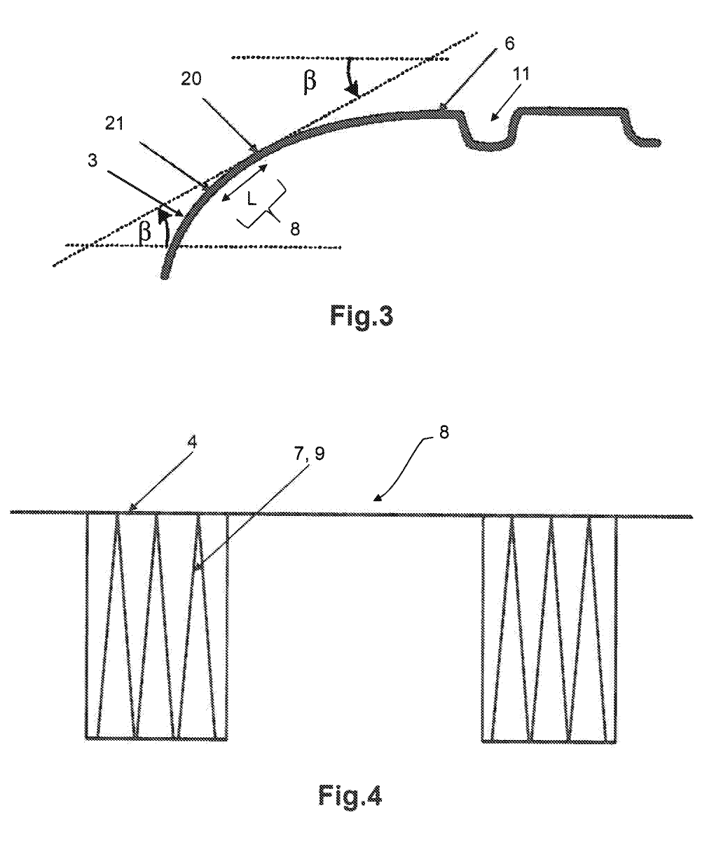

In nonlimiting examples, there are two methods used for determining the width L of the shoulder region 8.
The width L of the shoulder region 8 corresponds to the distance between a first axial edge 20 and a boundary 21. This boundary 21 passes close to the ends of the transverse grooves 11. More specifically, in the case of segmented moulds, this boundary 21 corresponds to the parting line of the mould between a shell of the mould (that moulds the sidewall) and mould segments (that mould the working region and the shoulder region of the tread). The way in which the width L of a shoulder region 8 is determined is illustrated in FIGS. 2 and 3 which each notably show the partial profile of a tread 2 and the part of a sidewall 3 that is adjacent thereto in a radial direction.
In certain tire designs, the transition from the tread 2 to the sidewalls 3 is very pronounced, as in the case depicted in FIG. 2, and it is easy to determine the first axial edge 20.
However, there are tire designs in which the transition between the tread 2 and the sidewalls 3 is a continuous one. One example is depicted in FIG. 3. In this figure, the first axial edge 20 of the tread 2 is determined as follows. The tangent to the tread surface at every point on the said tread surface in the region of transition to the sidewall 3 is plotted on a radial section of the tire. The first axial edge 20 is the point at which the angle β (beta) between the said tangent and an axial direction is equal to 30°. When there are a number of points for which the angle β between the said tangent and an axial direction is equal to 30°, it is the radially outermost point that is adopted.
The first axial edge 20 represents one of the ends of the shoulder region 8. The other end of the shoulder region 8 is the boundary 21 between the sidewall 3 and the grooves 11 of the tread 2. The width L of the shoulder region 8 is thus determined.

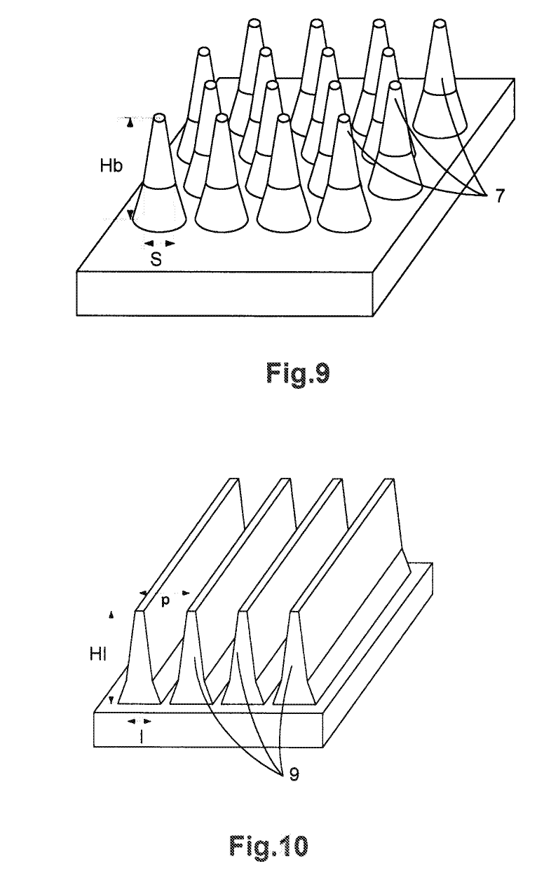

The graphic element 5 is in this instance completely filled with a texture. This texture comprises a plurality of strands 7, as depicted in FIG. 9. In that figure, the strands 7 have a conical overall shape with a cross section that decreases along the height Hb of these strands. More particularly, the mean section of each strand, which corresponds to the mean of the sections S measured at regular intervals from the base of the strand, is between 0.0007 mm² and 0.06 mm². Within the texture, the strands are distributed with a density at least equal to five strands per square millimetre.

In one alternative form of embodiment, the texture comprises a plurality of lamellae 9, as depicted in FIG. 10. In that figure, the lamellae 9 have a triangular overall cross section and the mean width of each lamella, corresponding to the mean of the widths l measured at regular intervals along the height H1 of the lamella, is between 0.03 mm and 0.3 mm. In the texture, the lamellae 9 are substantially mutually parallel and the spacing P of the lamellae is at least equal to 0.1 mm and at most equal to 0.5 mm.

In another alternative form of embodiment, the texture comprises a combination of strands 7 and of lamellae 9.
Thus, the texture (referred to as “velour”) of the graphic element 5 allows light to be absorbed thus making it easy to visualise the letters, numbers or symbols that make up the said graphic element 5. The parts complementary to the graphic element 5 that is to be visualised are themselves provided with a texture that encourages the reflecting of light back towards the observer. These are low-roughness textures. In the example of FIG. 1, the part complementary to the graphic element “o” is the centre of the said “o”. In one nonlimiting example, the complementary parts (namely those parts that are not inset) have a roughness with a mean amplitude of less than 0.2 mm. This then yields better contrast between the graphic element and the surrounding regions of the shoulder which reflect light.

FIG. 4 depicts a view in cross section of the texture present in the graphic element 5 according to a first embodiment of the disclosure. This texture comprises strands 7 and/or lamellae 9.

More particularly, the strands 7 of the texture or, respectively, the lamellae 9 of the texture here end flush with the sidewall 3 of the tire, namely the tips of these strands 7 or, respectively, the tips of these lamellae 9 lie at the same level as the upper surface 4 of the shoulder region 8.

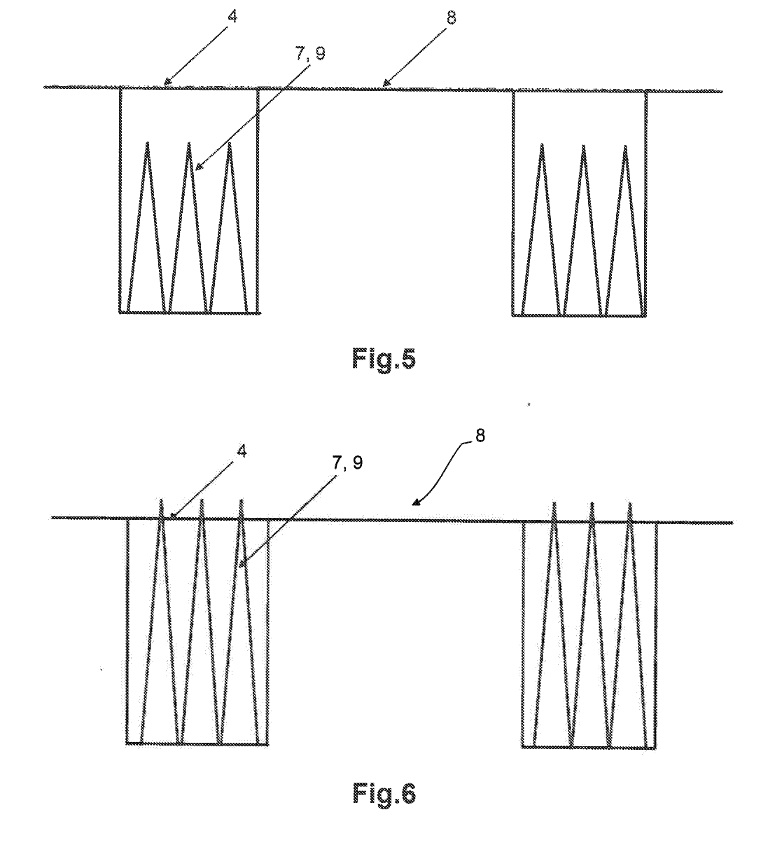

In one alternative form of embodiment visible in FIG. 5, the strands 7 of the texture or, respectively, the lamellae 9 of the texture, are set back with respect to the shoulder region 8, which means to say that the tips of these strands 7 or, respectively, the tips of these lamellae 11, lie below the top surface 4 of the shoulder region 8.

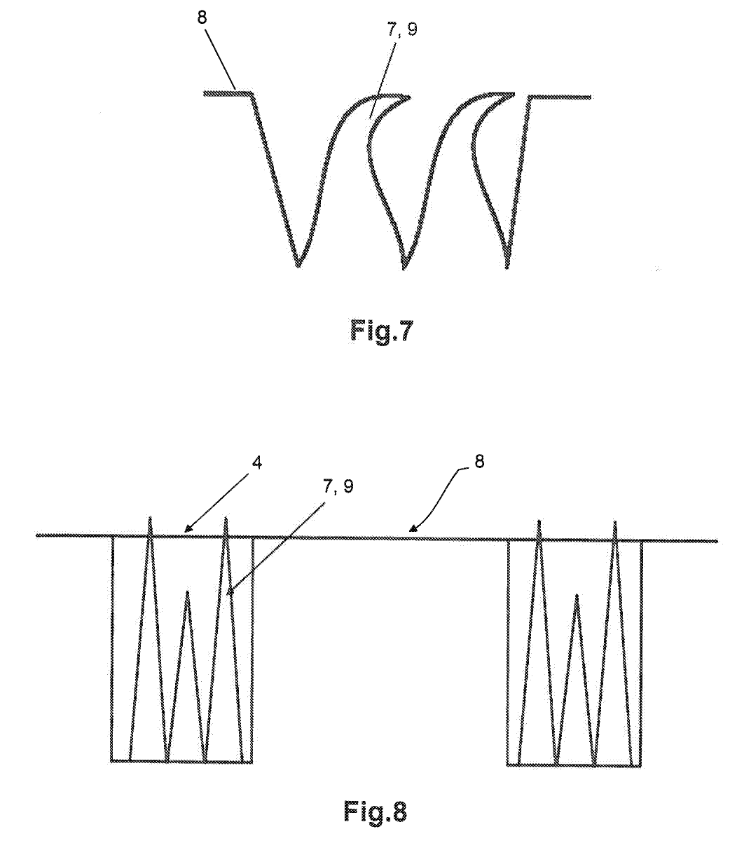

In another alternative form of embodiment visible in FIG. 6, the strands 7 of the texture or, respectively, the lamellae 9 of the texture, protrude beyond the shoulder region 8 of the tire, which means to say that the tips of these strands 7 or, respectively, the tips of these lamellae 9, protrude beyond the top surface 4 of the shoulder region 8. If the sidewall of the tire is rubbed in the region of the graphic element, the strands 7 or, respectively, the lamellae 9, flex, as can be seen in FIG. 7, thereby absorbing all or some of the force of this rubbing.

In another alternative form of embodiment visible in FIG. 8, part of the strands 7 of the texture or, respectively, part of the lamellae 9 of the texture, protrude beyond the top surface 4 of the shoulder region 8 of the tire, and another part of these strands 7 or, respectively, of these lamellae 9, are set back into the graphic element. For preference, at least 30% of the strands 7 or, respectively, of the lamellae 9, protrude beyond the top surface 4 of the shoulder region 8.

Thus, the fact of having the graphic element 5 inset and made up of strands and/or lamellae affords the graphic element 5 protection against kerbing. What happens is that the friction forces that would lead to abrasion are absorbed by the rigid parts of the shoulder region 8, and the pressure applied to the graphic element 5 as a result of the friction forces is low because of the flexibility of the said strands and/or lamellae.

The disclosure is not restricted to the examples described and depicted and various modifications can be made thereto without departing from its scope.

The sidewall of the tire may comprise other graphic elements which do not have a texture as described in the disclosure.

Finally, the lamellae 9 of FIG. 10 may be discontinuous. They may have flat parts between them. They may also have differences in cross section from one another. In addition, the lamellae may have curvatures or angles, notably along their length. Furthermore, they may be of variable length.

Thus the disclosure described notably offers the following advantages:
it makes it possible to obtain markings (graphic elements) that are resistant to abrasion of the kerbing type as compared with micro textures that are not inset, accordingly achieving markings that are long-lasting;
it makes it possible to obtain markings with very high visibility/contrast; and
it makes it possible to improve on the aerodynamics in the shoulder region by minimizing the use of raised markings in this region. The aerodynamic profile of the tire and, therefore, of the vehicle, is thus optimized.

1. A tire of elastomeric properties, comprising:
a tread having a shoulder region, and
a graphic element, wherein
the graphic element is recessed into the shoulder region, and
the graphic element includes a texture that contrasts with the shoulder region.

2. The tire according to claim 1, wherein the texture comprises a plurality of strands distributed in the graphic element at a density at least equal to five strands per square millimetre (mm²), each strand having a mean cross section of between 0.0007 mm² and 0.06 mm².

3. The tire according to claim 1, wherein the texture comprises a plurality of substantially mutually parallel lamellae, the spacing of the lamellae being at most equal to 0.5 mm, all or some of the lamellae having a mean width of between 0.03 mm and 0.3 mm.

4. The tire according to wherein the graphic element is selected from a group of graphic elements comprising at least:
letters;
numbers;
symbols.

5. The tire according to claim 2, wherein the strands of the graphic element or, respectively, the lamellae of the graphic element, end flush with the shoulder region of the tread of the tire.

6. The tire according to claim 2, wherein the strands of the graphic element or, respectively, the lamellae of the graphic element are set back in relation to the shoulder region of the tread of the tire.

7. The tire according to claim 2, wherein the strands of the graphic element or, respectively, the lamellae of the graphic element protrude beyond the shoulder region of the tread of the tire.

8. The tire according to claim 2, wherein the strands of the graphic element or, respectively, part of the lamellae of the graphic element protrude beyond the shoulder region of the tread of the tire and another part of these strands or, respectively, of these lamellae are set back in relation to this shoulder region.

9. The tire according to claim 1, wherein the tread further comprises at least two adjacent grooves opening into the shoulder region, the graphic element being situated between these two adjacent grooves.
